(19) United States
(12) Patent Application Publication
(10) Pub. No.: US 2012/0236565 A1
(43) Pub. Date: Sep. 20, 2012

(54) Lighting device

(75) Inventor: Ping-Chen Wu, New Taipei City (TW)

(73) Assignee: Unity Opto Technology Co., Ltd., New Taipei City (TW)

(21) Appl. No.: 13/064,830

(22) Filed: Apr. 20, 2011

(30) Foreign Application Priority Data
Mar. 16, 2011 (TW) 100204608

(51) Int. Cl. F21V 29/00; F21V 5/04

(52) U.S. Cl. 362/294; 362/311.01

(57) ABSTRACT

A lighting device includes a base, an optic lens assembly, and a light emission module. The base has an end forming an opening. The optic lens assembly is received in the opening and has a central portion forming a first light projection section and a circumferential portion that forms a second light projection section surrounding the first light projection section. The light emission module is received in the base and includes at least one first light emission element corresponding to the first light projection section and a plurality of second light emission elements which is arranged around the first light emission element and corresponds to the second light projection section. As such, the first light emission element emits light that is projected through the first light projection section and the second light emission elements emit light that is projected through the second light projection section to form a dual illumination zone arrangement that includes an inner illumination zone and an outer illumination zone so as to improve illuminance, reduce shaded surface area of a target object illuminated, and enhance visual effect.

### FIELD OF THE INVENTION

The present invention relates to a lighting device.

### BACKGROUND OF THE INVENTION

A conventional lighting device comprises a number of light-emitting diodes mounted therein. These light-emitting diodes are arranged to face in the same axial direction so that the light projected from the light-emitting diodes is concentrated in a central portion of an illumination zone, and a circumferential portion of the illumination exhibits reduced illuminance. Such a known device, when used to illuminate a target object, such as a fine art work including a statue and an installation, often forms a brightened surface on a localized area, but also forms shades on other surfaces of the target object, making it hard to visualize overall surface feature of the target object and causing poor lighting around the target object that leads to potential risk of viewer safety due to unexpected collision. A conventionally adopted solution is to increase the number of lighting devices used in order to provide sufficient brightness. This requires additional costs and increases the time needed for installing and removing the lighting device. If the number of lighting device so increased is still insufficient, the same problem exists.

Thus, the present invention aims to provide a lighting device that provides dual illumination zones and increases illuminance so as to lessen the shaded surface area of a target object illuminated by the lighting device, improve visual effect, and enhance safety.

### SUMMARY OF THE INVENTION

An objective of the present invention is to provide a lighting device that provides dual illumination zones and increases illuminance so as to lessen the shaded surface area of a target object illuminated by the lighting device, improve visual effect, and enhance safety.

To realize the above objective, the present invention provides a lighting device, comprising: a base, which has an end forming an opening; an optic lens assembly, which is received in the opening and has a central portion forming a first light projection section and a circumferential portion that forms a second light projection section surrounding the first light projection section; and a light emission module, which is received in the base and comprises at least one first light emission element corresponding to the first light projection section of the optic lens assembly and a plurality of second light emission elements which is arranged around the first light emission element and corresponds to the second light projection section of the optic lens assembly. As such, the present invention provides a lighting device comprising a combined arrangement of a base, an optic lens assembly, and a light emission module, wherein the first light emission element emits light that is projected through the first light projection section to form an inner illumination zone and the second light emission elements emit light that is projected through the second light projection section to form an outer illumination zone circumferentially encompassing the inner illumination zone thereby forming dual illumination zones that helps improving illuminance and reducing shaded surface area of a target object illuminated so as to improve visual effect and enhance safety.

### BRIEF DESCRIPTION OF THE DRAWINGS

The present invention will be apparent to those skilled in the art by reading the following description of a preferred embodiment thereof with reference to the drawings, in which:

FIG. 1 is a perspective view of a lighting device according to the present invention;

FIG. 2 is an exploded view of FIG. 1;

FIG. 3 is a top plan view of the lighting device according to the present invention;

FIG. 4A is a cross-sectional view taken along line A-A of FIG. 3;

FIG. 4B is a cross-sectional view taken along line B-B of FIG. 3;

FIG. 4C is an enlarged view of a portion of FIG. 4A that includes the first light projection section of the optic lens assembly; and

FIG. 5 is a schematic view illustrating an application of the lighting device according to the present invention.

### DETAILED DESCRIPTION OF THE PREFERRED EMBODIMENT

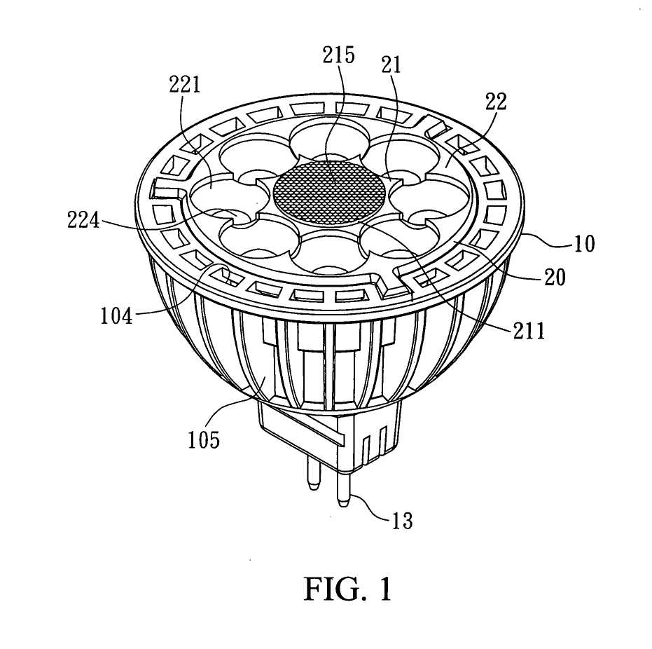

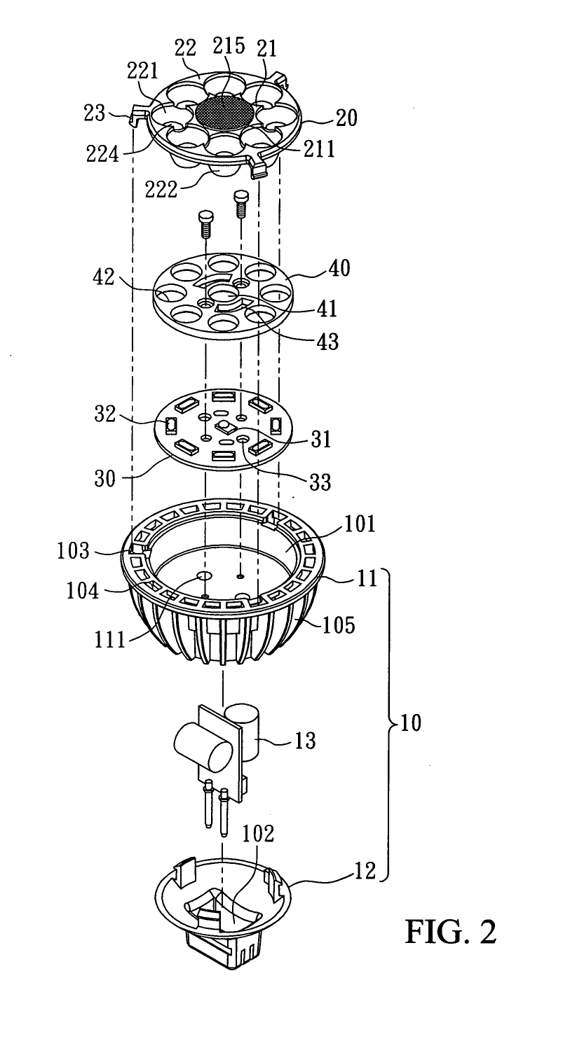

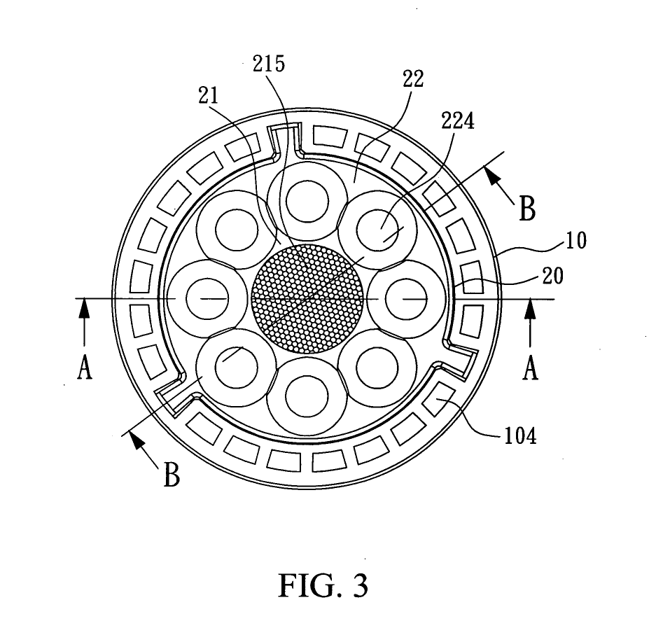

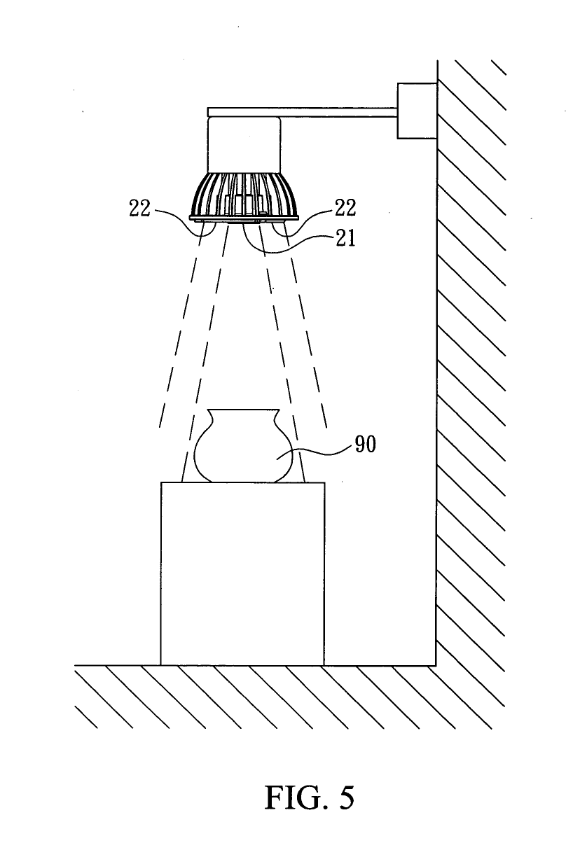

With reference to the drawings and in particular to FIGS. 1-5, a lighting device comprises a base 10, an optic lens assembly 20, and a light emission module 30.

The base 10 has an end forming an opening 101. The optic lens assembly 20 is received in the opening 101. The optic lens assembly 20 has a central portion forming a first light projection section 21 and a circumferential portion that forms a second light projection section 22 surrounding a circumference of the first light projection section 21. The light emission module 30 is received in the base 10. The light emission module 30 comprises at least one first light emission element 31, which is arranged to correspond to the first light projection section 21 of the optic lens assembly 20, and a plurality of second light emission elements 32, which is arranged to distribute around the first light emission elements 31 and correspond to the second light projection section 22 of the optic lens assembly 20.

As such, the first light emission element 31 emits light that is projected through the first light projection section 21 to form an inner illumination zone; and the second light emission elements 32 emit light that is projected through the second light projection section 22 to form an outer illumination zone that circumferentially encompass the inner illumination zone thereby providing a lighting effect of dual illumination zones, which helps improving illuminance and reducing the shaded surface area of a target object illuminated; and the doula-zone lighting provides a visual effect of layered aesthetic perception and improves safety.

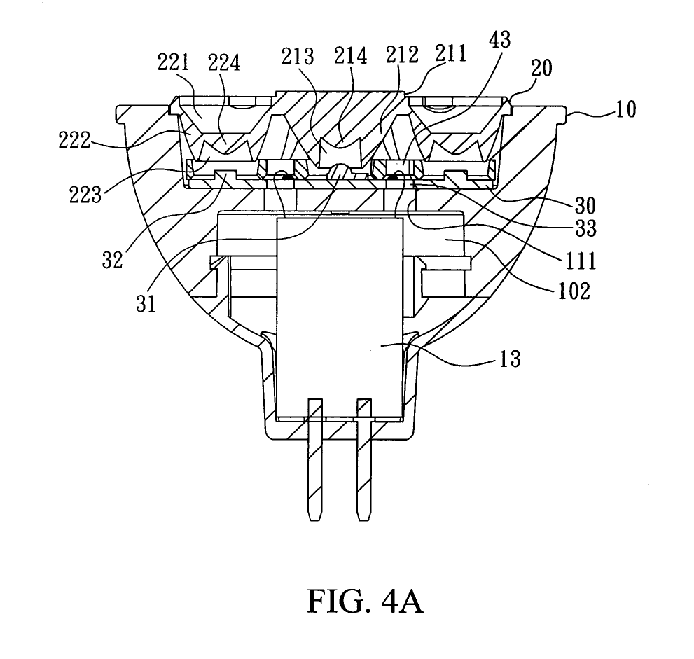

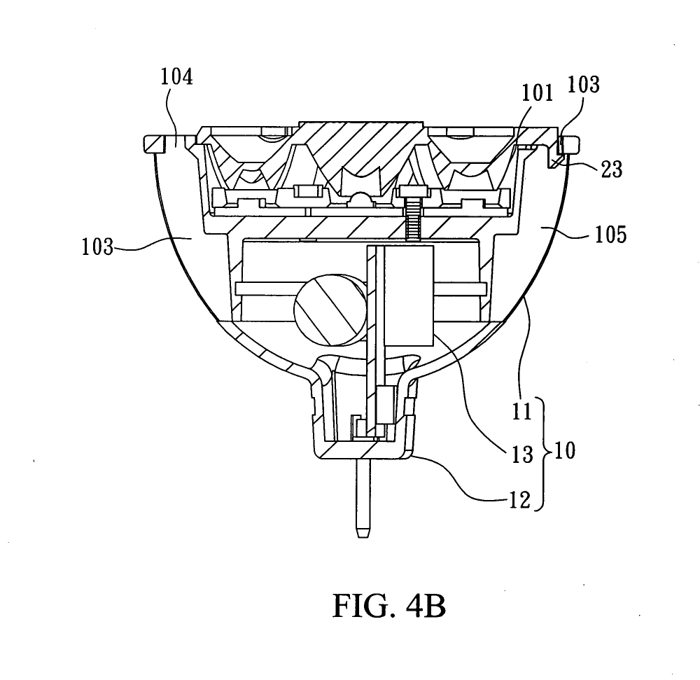

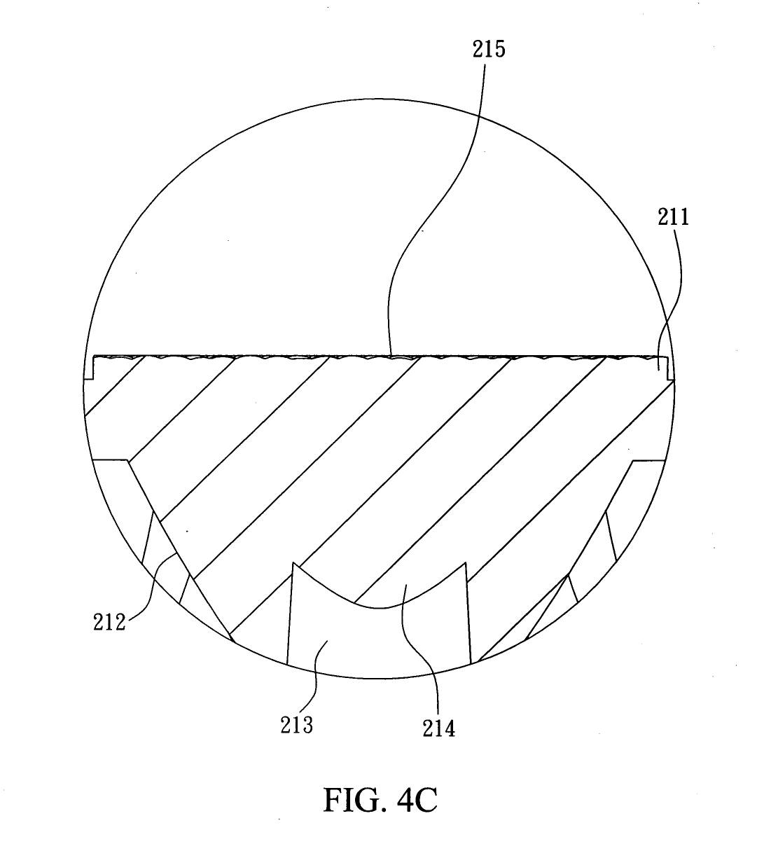

In an embodiment, the light emission module 30 is implemented in the form of a circuit board, which is secured inside the base 10 by fasteners (see FIG. 4B). The first light emission element 31 is embodied with a large power light-emitting diode, and the second light emission elements 32 are medium power light-emitting diodes. The base 10 is made in the form of a socket, which is composed of an upper casing member 11, a lower casing member 12, and a power supply unit 13. The upper casing member 11 and the lower casing member 12 mate each other to form a receiving space 102 inside the base 10 for receiving therein the power supply unit 13. This arrangement allows the power supply unit 13 to be spaced and separated from the light emission module 30 thereby eliminating undesired mutual influence caused by thermal energies emitting therefrom.

The power supply unit 13 has an end extending through the lower casing member 12 for selective connection with an external power source and an opposite end to which electrical wires are connected. The upper casing member 11 forms at least one internal passage 111, whereby the electrical wires may pass through the passage to electrically connect to the light emission module 30 (see FIG. 4A). The upper casing member 11 and the lower casing member 12 are structured to easily separate from each other and this facilitate removal and replacement of the power supply unit 13.

The first light projection section 21 comprises a first raised portion 211 and a second raised portion 212 that are respectively formed on opposite surfaces of the optic lens assembly 20 and correspond to each other. The second raised portion 212 forms, in a middle portion thereof, a first light guide cavity 213 that is arranged to oppose the first light emission element 31. The second light projection section 22 comprises a first recessed chamber 221 and a third raised portion 222 that are respectively formed on the opposite surfaces of the optic lens assembly 20 and correspond to each other. The third raised portion 222 forms, in a middle portion thereof, a second light guide cavity 223 that is arranged to oppose the second light emission elements 32.

Further, a first lens structure 214 is formed inside the first light guide cavity 213, and a second lens structure 224 is formed between the first recessed chamber 221 and the second light guide cavity 223.

The present invention provides such an arrangement that the second raised portion 212 is located close to the first light emission elements 31, so that the light emitting from the first light emission elements 31 is allowed to directly enter the first light guide cavity 213 to be projected through the first lens structure 214. The third raised portion 222, the second light guide cavity 223, the second light emission elements 32, and the second lens structure 224 are arranged in substantially the same way.

According to the present invention, the first lens structure 214 can be one of a plane-convex lens, a concave-convex lens, a double-convex lens, a plane-concave lens, and a double-concave lens. The second lens structure 224 can be of the same structure as the first lens structure 214 or a different structure. This improves the lighting effect of the dual illumination zone arrangement according to the present invention.

Further, the first raised portion 211 has an outside surface that is formed as a light diffraction surface 215, which functions to diffract light so that no irritation of eyes caused by intense light from the high power light-emitting diode (namely the first light emission element 31) may occur and luminous intensities of the lights emitting from the first light emission element 31 and the second light emission elements 32 projecting through the first light projection section 21 and the second light projection section 22 may get substantially homogenous with respect to each other, allowing the inner illumination zone and the outer illumination zone be visually combined as an enlarged illumination area of homogenous illuminance.

A board 40 is arranged between the optic lens assembly 20 and the light emission module 30. The board 40 forms at least one first through hole 41 in a central portion thereof and a plurality of second through holes 42 distributed around a circumference of the first through hole 41 for respectively guiding the lights emitting from the first light emission element 31 and the second light emission elements 32 in a concentrated manner to pass through respective light guide cavities and lens for outward projection.

The light emission module 30 forms at least one channel 33 located between the first light emission element 31 and the second light emission elements 32, and the board 40 forms at least one corresponding channel 43. The channel 43 is a curved elongate slot and substantially opposes the channel 33, whereby electrical connection of the electrical wires of the power supply unit 13 to the light emission module 30 may be facilitated.

The optic lens assembly 20 has a circumference that forms at least one retention pawl 23. The base 10 has a circumference forming at least one retention slot 103. The retention slot 103 and the retention pawl 23 are engageable with each other (see FIG. 4B). This arrangement facilitates removal and replacement of the optic lens assembly 20.

The base 10 also forms in the circumference thereof [symbol] a plurality of heat dissipation apertures 104, and a plurality of heat dissipation fins 105 is formed on a circumferential outside surface of the base 10, both facilitating heat dissipation.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A lighting device, comprising:
a base, which has an end forming an opening;
an optic lens assembly, which is received in the opening and has a central portion forming a first light projection section and a circumferential portion that forms a second light projection section surrounding the first light projection section; and
a light emission module, which is received in the base and comprises at least one first light emission element, which corresponds to the first light projection section of the optic lens assembly and a plurality of second light emission elements which is arranged around the first light emission element and corresponds to the second light projection section of the optic lens assembly;
wherein the first light emission element emits light that is projected through the first light projection section and the second light emission elements emit light that is projected through the second light projection section to form dual illumination zones.

2. The lighting device as claimed in claim 1, wherein the base comprises an upper casing member, a lower casing member, and a power supply unit, the upper casing member being coupled to the lower casing member to form a receiving space inside the base to receive therein the power supply unit that is adapted to connect to an external power source, the power supply unit being in electrical connection with the light emission module.

3. The lighting device as claimed in claim 1, wherein the first light projection section comprises a first raised portion and a second raised portion that are respectively formed on opposite surfaces of the optic lens assembly and correspond to each other, the second raised portion forming in a middle portion thereof a first light guide cavity that opposes the first light emission element, the second light projection section comprising a first recessed chamber and a third raised portion that are respectively formed on the opposite surfaces of the optic lens assembly and correspond to each other, the third raised portion forming in a middle portion thereof a second light guide cavity opposing the second light emission elements.

4. The lighting device as claimed in claim 3, wherein the first light guide cavity forms therein a first lens structure, and the first recessed chamber and the second light guide cavity form therebetween a second lens structure.

5. The lighting device as claimed in claim 3, wherein the first raised portion has an outside surface forming a light diffraction surface.

6. The lighting device as claimed in claim 1, wherein the optic lens assembly and the light emission module receive a board arranged therebetween, the board forming at least one first through hole in a central portion thereof and a plurality of second through holes distributed around the first through hole for respectively guiding lights emitting from the first light emission element and the second light emission elements to pass through respective light guide cavities and lenses for outward projection.

7. The lighting device as claimed in claim 6, wherein the light emission module forms at least one channel located between the first light emission element and the second light emission elements and the board forms at least one corresponding channel that substantially opposes the channel of the light emission module to facilitate electrical connection.

8. The lighting device as claimed in claim 1, wherein the optic lens assembly has a circumference forming at least one retention pawl, and the base has a circumference forming at least one retention slot, the retention slot and the retention pawl being engageable with each other.

9. The lighting device as claimed in claim 1, wherein the base has a circumference forming a plurality of heat dissipation apertures and a circumferential outside surface forming a plurality of heat dissipation fins.
